(19) United States
(12) Patent Application Publication
(10) Pub. No.: US 2019/0169412 A1
(43) Pub. Date: Jun. 6, 2019

(54) THERMOPLASTIC ELASTOMER COMPOSITION AND GLASS RUN

(71) Applicant: TOYODA GOSEI CO., LTD., Kiyosu-shi (JP)

(72) Inventors: Atsuko SATO, Kiyosu-shi (JP); Yasuhiro YAMAGUCHI, Kiyosu-shi (JP); Hidekazu KURIMOTO, Kiyosu-shi (JP)

(21) Appl. No.: 15/895,013

(22) Filed: Feb. 13, 2018

(30) Foreign Application Priority Data
Mar. 30, 2017 (JP) 2017-067332

(51) Int. Cl. C08L 23/16; C08L 23/14; B60J 10/76; B60J 10/15

(52) U.S. Cl. CPC C08L 23/16; C08L 23/14; B60J 10/76; B60J 10/27; C08L 2205/03; C08L 2207/04; B60J 10/15

(57) ABSTRACT

A thermoplastic elastomer composition contains 22 to 50 parts by mass of a crosslinked ethylene/propylene/non-conjugated diene copolymer (A), 25 to 66 parts by mass of a 4-methyl-1-pentene/propylene copolymer (B), and 13 to 30 parts by mass of polypropylene (C), based on 100 parts by mass of a total of (A), (B), and (C).

### TECHNICAL FIELD

The present invention relates to a thermoplastic elastomer composition and a glass run containing the same.

### BACKGROUND ART

In recent years, there have been increased types and number of sales of vehicles temporarily or entirely driving using only electric motors such as a hybrid vehicle (HV), a plug-in hybrid vehicle (PHV), a fuel cell vehicle (FCV), and an electric vehicle (EV). Since the vehicle has no engine noise during driving using only the electric motor, some say that noise entering the vehicle from the outside thereof enters driver's ears without being masked by the engine noise, which distracts the driver in the opinion. Then, there is an increased need for decreasing the noise as compared with a conventional vehicle.

Vehicle exterior noise vibrates a windowpane, and largely enters the vehicle. It is found that the vibration of the windowpane is damped (suppressed) when a glass run abuts on the windowpane. Then, if vibration damping property can be improved by considering the material of the glass run, the noise entering the vehicle can be reduced.

On the other hand, ethylene/propylene/non-conjugated diene copolymer (EPDM) rubber is mainly used for the material of a conventional glass run. In the glass run, an extrusion-molded part as a substantial straight line portion and a die-molded part as a corner portion are manufactured by vulcanizing adhesion during die-molding. However, from the viewpoints of productivity and environmental correspondence, an olefin thermoplastic elastomer unrequiring a vulcanizing process is used for the material of a recent glass run, and the glass run is increasingly manufactured by die-connecting the extrusion-molded part and the die-molded part to each other during die-molding. Then, the blended amount of the olefin thermoplastic elastomer used for the material of the glass run is preferably considered to improve vibration damping property.

Conventionally, a polymer material having a large peak value of loss coefficient tan 8, as obtained by measuring a dynamic viscoelasticity thereof has been used as a vibration damping material, the loss coefficient tan 8 being an indicator of vibration damping property of the polymer material. Examples of the material include a styrene-isoprene-styrene block copolymer (SIS), a styrene-isobutylene-styrene block copolymer (SIBS), or a hydrogen additive (hydrogenated product) thereof. Then, SIS or SIBS is considered to be blended into the olefin thermoplastic elastomer of the glass run. However, in this case, the present inventors found that insufficient connection strength is disadvantageously obtained when the extrusion-molded part and the die-molded part as the corner portion are connected during die-molding.

Therefore, the present inventors examined and considered the vibration damping properties of many materials other than SIS and SIBS. As a result, the present inventors found that the relaxation time (spin-spin relaxation time) of pulse nuclear magnetic resonance (NMR) being an indicator of molecular mobility and the vibration damping property are negatively correlated with each other (the shorter the relaxation time is, the higher the vibration damping property is), and focused attention on a 4-methyl-1-pentene copolymer having a short relaxation time.

A 4-methyl-1-pentene/α-olefin copolymer is disclosed in Patent Document 1. Use of a propylene-α olefin copolymer for a portion abutting on a run channel part of a glass run is disclosed in Patent Document 2. Examples of the a olefin include 4-methyl-1-pentene.

However, it is difficult to blend the 4-methyl-1-pentene copolymer into the olefin thermoplastic elastomer of the glass run so that characteristics such as vibration damping property with respect to the windowpane, connection strength due to die-molding, and compression set (CS) are fulfilled at high levels.

### CITATION LIST

### Patent Document

Patent Document 1: Japanese Patent No. 5762303
Patent Document 2: Japanese Patent No. 3778856

### SUMMARY OF INVENTION

### Technical Problem

Then, it is an object of the present invention to provide a glass run capable of fulfilling characteristics such as vibration damping property with respect to glass, connection strength due to die-molding, and compression set at high levels, and a thermoplastic elastomer composition therefor.

### Solution to Problem

[1] A thermoplastic elastomer composition contains: 22 to 50 parts by mass of a crosslinked EPDM (A); 25 to 66 parts by mass of a 4-methyl-1-pentene/propylene copolymer (B); and 13 to 30 parts by mass of polypropylene (PP) (C), based on 100 parts by mass of a total of (A), (B), and (C).

Herein, the 4-methyl-1-pentene/propylene copolymer (B) preferably contains a 4-methyl-1-pentene component and a propylene component in a ratio of 65:35 to 80:20.

It is preferable that the thermoplastic elastomer composition further contains 30 to 60 parts by mass of oil (D) and 10 to 20 parts by mass of a filler (E).

[2] A glass run includes at least a seal lip made of the thermoplastic elastomer composition.

[3] A glass run includes an extrusion-molded part and a die-molded part die-connected to the extrusion-molded part, wherein the extrusion-molded part and the die-molded part are made of the thermoplastic elastomer composition.

<Operation>

A thermoplastic elastomer composition of the present invention is an olefin thermoplastic elastomer having a soft segment made of crosslinked EPDM (A) and a hard segment made of a 4-methyl-1-pentene/propylene copolymer (B) and PP (C). Therefore, the thermoplastic elastomer composition has a low environment load and high recycling efficiency.

The thermoplastic elastomer composition contains (A), (B), and (C) at the above-mentioned mass ratios, which provides a degree of noise insulation attenuation of 30 dB or more in a method to be described later (correlated with vibration damping property with respect to glass), connection strength of 3.1 MPa or more due to die-molding, and compression set (CS) of 65% or less. That is, these characteristics are fulfilled at high levels.

### (A) Crosslinked EPDM

The mass ratio of crosslinked EPDM (A) is set to 22 to 50 parts by mass since the mass ratio of less than 22 parts by mass causes insufficient compression set and the mass ratio of more than 50 parts by mass causes an insufficient degree of noise insulation attenuation. The mass ratio is preferably 24 to 45 parts by mass.

### (B) 4-Methyl-1-Pentene/Propylene Copolymer

The mass ratio of the 4-methyl-1-pentene/propylene copolymer (B) is set to 25 to 66 parts by mass since the mass ratio of less than 25 parts by mass causes insufficient vibration damping property and the mass ratio of more than 66 parts by mass causes insufficient connection strength and compression set. The mass ratio is preferably 30 to 60 parts by mass.

The reason why the ratio of a 4-methyl-1-pentene component to a propylene component in (B) is preferably 65:35 to 80:20 is that the ratio of the 4-methyl-1-pentene component of less than the range tends to cause deterioration in vibration damping property and the ratio of more than the range tends to cause a decrease in connection strength.

### (C) PP

The mass ratio of PP (C) is set to 13 to 30 parts by mass since the mass ratio of less than 13 parts by mass causes insufficient connectivity and the mass ratio of more than 30 parts by mass causes an insufficient degree of noise insulation attenuation.

### (D) Oil

Examples of the oil (D) include, but are not particularly limited to, process oil and extender oil. Examples of components of the oil include paraffin-based oil, naphthene-based oil, aromatic oil, or a blend thereof. When the thermoplastic elastomer composition contains 30 to 60 parts by mass of the oil, the composition is softened, which provides an improvement in processability.

### (E) Filler

Examples of the filler (E) include, but are not particularly limited to, clay, talc, and carbon black. When the thermoplastic elastomer composition contains 10 to 20 parts by mass of the filler, the filler acts as a reinforcing material of the composition.

(Other Blended Materials)

The thermoplastic elastomer composition may contain blended materials such as a colorant, a dispersant, and a stabilizer in addition to the materials.

A glass run made of the thermoplastic elastomer composition is suitable for a glass run of a vehicle and the like, and particularly suitable for the glass run of the vehicle temporarily or entirely driving using only the electric motor.

### Advantageous Effects of Invention

The present invention can provide a glass run capable of fulfilling characteristics such as vibration damping property with respect to glass, connection strength due to die-molding, and compression set at high levels, and a thermoplastic elastomer composition therefor.

### BRIEF DESCRIPTION OF DRAWINGS

FIG. 1A is a side view showing a door of a vehicle and a glass run of an embodiment;

FIG. 1B is a side view of the glass run;

FIG. 2 is a sectional view taken along line II-II in FIG. 1A; and

FIG. 3 is a perspective view of a test piece in which connection strength due to die-molding is measured.

### DESCRIPTION OF EMBODIMENTS

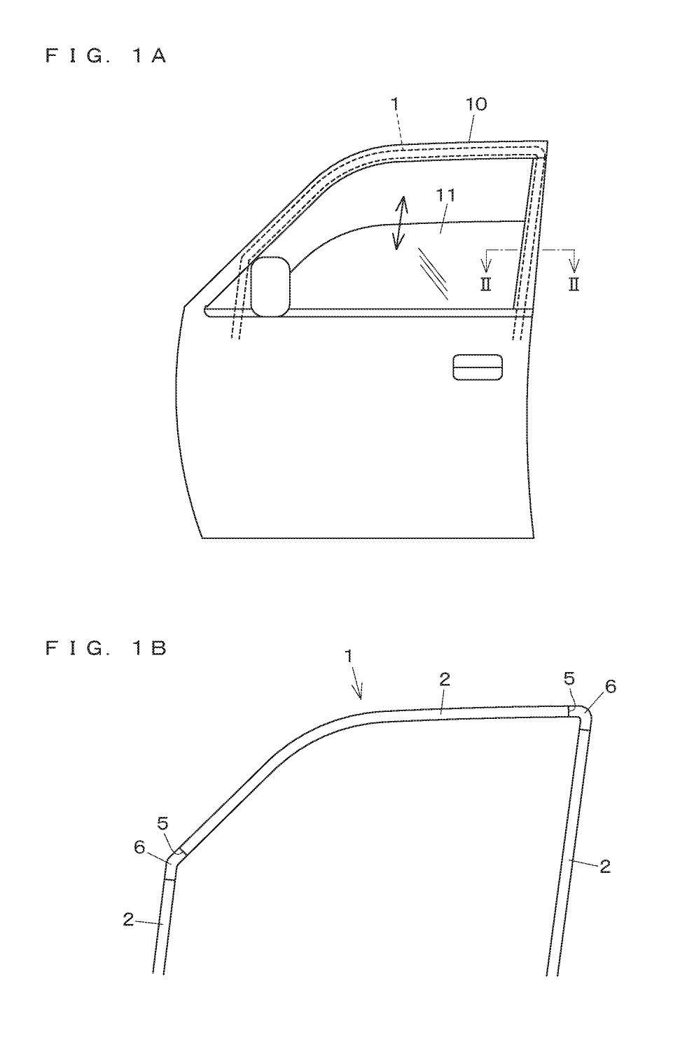

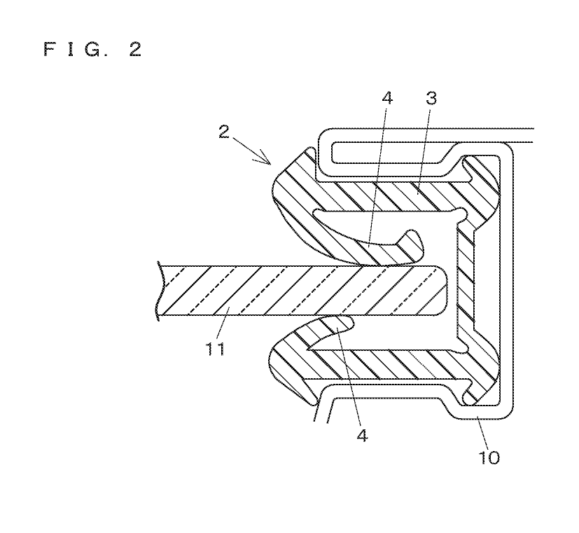

As shown in FIGS. 1A and 1B, a glass run 1 attached to a door sash 10 of a vehicle is obtained by connecting an extrusion-molded part 2 to a die-molded part 6 placed at a corner. As shown in FIG. 2, the extrusion-molded part 2 includes a trim part 3 having a substantial U-sectional shape, and a pair of seal lip parts 4 obliquely extending on an inner side so as to come close to each other from both opening end parts of the trim part 3. The die-molded part 6 is also fundamentally configured as with the extrusion-molded part 2 (the sectional view is abbreviated). A windowpane 11 moves up and down between the pair of seal lip parts 4 while sliding thereon. The pair of seal lip parts 4 provide a seal between the seal lip part and the windowpane 11, and damp the vibration of the windowpane 11 to improve noise barrier performance.

In the extrusion-molded part 2, both the trim part 3 and the seal lip parts 4 are obtained by extrusion-molding a thermoplastic elastomer composition containing 22 to 50 parts by mass of crosslinked EPDM (A), 25 to 66 parts by mass of a 4-methyl-1-pentene/propylene copolymer (B), and 13 to 30 parts by mass of PP (C), based on 100 parts by mass of a total of (A), (B), and (C). The thermoplastic elastomer composition further contains 30 to 60 parts by mass of oil (D) and 10 to 20 parts by mass of a filler (E).

The die-molded part 6 is obtained by die-molding the same thermoplastic elastomer composition as that of the extrusion-molded part 2 and simultaneously the die-molded part 6 is die-connected to a cut edge 5 of the extrusion-molded part 2.

### Examples

Examples having blended materials and component amounts shown in the following Table 1 were produced as compositions for an extrusion-molded part 2 and a die-molded part 6 of a glass run 1. Furthermore, Comparative Examples were also produced, to measure and compare characteristics.

TABLE 1

| | | | Example 1 | Example 2 | Example 3 | Example 4 | Example 5 |
|---|---|---|---|---|---|---|---|
| Blended materials | Dynamic | (A) Crosslinked EPDM: 30 wt % | 82 | 80 | 75 | 70 | 60 |
| Mass ratios | crosslinking-type | (C) PP: 18 wt % | | | | | |
| (Parts by mass) | olefin thermoplastic | (D) Process oil: 39 wt % | | | | | |
| | elastomer | (E) Clay: 13 wt % | | | | | |
| | Olefin thermoplastic | (B) 4-methyl-1-pentene/propylene | 18 | 20 | 25 | 30 | 40 |
| | elastomer (TPO) | copolymer | | | | | |
| | | (4-methyl-1-pentene component: | | | | | |
| | | 70 wt %, propylene component: 30 wt %) | | | | | |
| | Styrene thermoplastic | (F) SIS | 0 | 0 | 0 | 0 | 0 |
| | elastomer (TPS)-1 | | | | | | |
| | Styrene thermoplastic | (F) SIS (hydrogenated) | 0 | 0 | 0 | 0 | 0 |
| | elastomer (TPS)-2 | | | | | | |

| Component amounts | (Based on A + B or F + C = 100 parts by mass) | | 42.9 | 41.1 | 36.9 | 33.0 | 26.2 |
|---|---|---|---|---|---|---|---|
| Mass ratios | (A) Crosslinked EPDM amount | | | | | | |
| (Parts by mass) | (Based on A + B or F + C = 100 parts by mass) | | 31.4 | 34.2 | 41.0 | 47.2 | 58.1 |
| | (B) 4-methyl-1-pentene/propylene copolymer amount | | | | | | |
| | (Based on A + B or F + C = 100 parts by mass) | | 25.7 | 24.7 | 22.1 | 19.8 | 15.7 |
| | (C) PP amount | | | | | | |
| | (Based on A + B or F + C = 100 parts by mass) | | 55.8 | 53.4 | 48.0 | 42.9 | 34.0 |
| | (D) Process oil amount | | | | | | |
| | (Based on A + B or F + C = 100 parts by mass) | | 18.6 | 17.8 | 16.0 | 14.3 | 11.3 |
| | (E) Clay amount | | | | | | |
| | (Based on A + B or F + C = 100 parts by mass) | | 0 | 0 | 0 | 0 | 0 |
| | (F) SIS amount | | | | | | |
| Characteristics | Average Relaxation Time [μs] | Desired value: | 820 | 745 | 637 | 543 | 440 |
| | | 900 μs or less | Good | Good | Good | Good | Good |
| | Degree of Noise Insulation | Desired value: | 34 | 35 | 36 | 37 | 40 |
| | Attenuation [dB] | 30 dB or more | Good | Good | Good | Good | Good |
| | Connection Strength [MPa] | Desired value: | 3.3 | 3.3 | 3.5 | 3.4 | 3.1 |
| | | 3.1 MPa or more | Good | Good | Good | Good | Good |
| | Compression Set (CS) [%] | Desired value: | 49 | 50 | 53 | 57 | 64 |
| | | 65% or less | Good | Good | Good | Good | Good |

| | | | Comparative | Comparative | Comparative | Comparative |
|---|---|---|---|---|---|---|
| | | | Example 1 | Example 2 | Example 3 | Example 4 |
| Blended materials | Dynamic | (A) Crosslinked EPDM: 30 wt % | 100 | 50 | 25 | 0 |
| Mass ratios | crosslinking-type | (C) PP: 18 wt % | | | | |
| (Parts by mass) | olefin thermoplastic | (D) Process oil: 39 wt % | | | | |
| | elastomer | (E) Clay: 13 wt % | | | | |
| | Olefin thermoplastic | (B) 4-methyl-1-pentene/propylene | 0 | 50 | 75 | 100 |
| | elastomer (TPO) | copolymer | | | | |
| | | (4-methyl-1-pentene component: | | | | |
| | | 70 wt %, propylene component: 30 wt %) | | | | |
| | Styrene thermoplastic | (F) SIS | 0 | 0 | 0 | 0 |
| | elastomer (TPS)-1 | | | | | |
| | Styrene thermoplastic | (F) SIS (hydrogenated) | 0 | 0 | 0 | 0 |
| | elastomer (TPS)-2 | | | | | |

| Component amounts | (Based on A + B or F + C = 100 parts by mass) | | 62.5 | 20.3 | 8.6 | 0 |
|---|---|---|---|---|---|---|
| Mass ratios | (A) Crosslinked EPDM amount | | | | | |
| (Parts by mass) | (Based on A + B or F + C = 100 parts by mass) | | 0 | 67.6 | 86.2 | 100 |
| | (B) 4-methyl-1-pentene/propylene copolymer amount | | | | | |
| | (Based on A + B or F + C = 100 parts by mass) | | 37.5 | 12.2 | 5.2 | 0 |
| | (C) PP amount | | | | | |
| | (Based on A + B or F + C = 100 parts by mass) | | 81.3 | 26.4 | 11.2 | 0 |
| | (D) Process oil amount | | | | | |
| | (Based on A + B or F + C = 100 parts by mass) | | 27.1 | 8.8 | 3.7 | 0 |
| | (E) Clay amount | | | | | |
| | (Based on A + B or F + C = 100 parts by mass) | | 0 | 0 | 0 | 0 |
| | (F) SIS amount | | | | | |
| Characteristics | Average Relaxation Time [μs] | Desired value: | 1371 | 284 | 95 | 16 |
| | | 900 μs or less | Poor | Good | Good | Good |
| | Degree of Noise Insulation | Desired value: | 29 | 42 | 49 | 54 |
| | Attenuation [dB] | 30 dB or more | Poor | Good | Good | Good |
| | Connection Strength [MPa] | Desired value: | 3.2 | 3 | 2.9 | 2.9 |
| | | 3.1 MPa or more | Good | Poor | Poor | Poor |
| | Compression Set (CS) [%] | Desired value: | 39 | 76 | 100 | 99 |
| | | 65% or less | Good | Poor | Poor | Poor |

| | | | Comparative | Comparative |
|---|---|---|---|---|
| | | | Example 5 | Example 6 |
| Blended materials | Dynamic | (A) Crosslinked EPDM: 30 wt % | 75 | 75 |
| Mass ratios | crosslinking-type | (C) PP: 18 wt % | | |
| (Parts by mass) | olefin thermoplastic | (D) Process oil: 39 wt % | | |
| | elastomer | (E) Clay: 13 wt % | | |
| | Olefin thermoplastic | (B) 4-methyl-1-pentene/propylene | 0 | 0 |
| | elastomer (TPO) | copolymer | | |
| | | (4-methyl-1-pentene component: | | |
| | | 70 wt %, propylene component: 30 wt %) | | |
| | Styrene thermoplastic | (F) SIS | 25 | 0 |
| | elastomer (TPS)-1 | | | |
| | Styrene thermoplastic | (F) SIS (hydrogenated) | 0 | 25 |
| | elastomer (TPS)-2 | | | |

| Component amounts | (Based on A + B or F + C = 100 parts by mass) | | 36.9 | 36.9 |
|---|---|---|---|---|
| Mass ratios | (A) Crosslinked EPDM amount | | | |
| (Parts by mass) | (Based on A + B or F + C = 100 parts by mass) | | 0 | 0 |
| | (B) 4-methyl-1-pentene/propylene copolymer amount | | | |
| | (Based on A + B or F + C = 100 parts by mass) | | 22.1 | 22.1 |
| | (C) PP amount | | | |
| | (Based on A + B or F + C = 100 parts by mass) | | 48.0 | 48.0 |
| | (D) Process oil amount | | | |
| | (Based on A + B or F + C = 100 parts by mass) | | 16.0 | 16.0 |
| | (E) Clay amount | | | |
| | (Based on A + B or F + C = 100 parts by mass) | | 41.0 | 41.0 |
| | (F) SIS amount | | | |
| Characteristics | Average Relaxation Time [μs] | Desired value: | 847 | 881 |
| | | 900 μs or less | Good | Good |
| | Degree of Noise Insulation | Desired value: | 34 | 34 |
| | Attenuation [dB] | 30 dB or more | Good | Good |
| | Connection Strength [MPa] | Desired value: | 2.9 | 3 |
| | | 3.1 MPa or more | Poor | Poor |
| | Compression Set (CS) [%] | Desired value: | 70 | 81 |
| | | 65% or less | Poor | Poor |

Herein, the materials will be described in detail as follows.
Dynamic crosslinking-type olefin thermoplastic elastomer (TPV): This is “Santoprene 121-73W175” (trade name) manufactured by Exxon Corporation. The analysis results of components included 30% by mass of crosslinked EPDM, 18% by mass of PP, 39% by mass of process oil, and 13% by mass of clay. The average relaxation time of pulse NMR was 1371 μs.
Olefin thermoplastic elastomer (TPO): This is “Absortmer EP-1001” (trade name) manufactured by Mitsui Chemicals, Inc., and a 4-methyl-1-pentene/propylene copolymer (4-methyl-1-pentene component: 70% by mass, propylene component: 30% by mass). The average relaxation time of pulse NMR was 15.7 μs.
Styrene thermoplastic elastomer (TPS)-1: This is “Hybrar 5127” (trade name) manufactured by Kuraray Co., Ltd. (component: SIS). The average relaxation time of pulse NMR was 17.3 μs.
Styrene thermoplastic elastomer (TPS)-2: This is “Hybrar 7125” (trade name) manufactured by Kuraray Co., Ltd. (component: hydrogenated SIS). The average relaxation time of pulse NMR was 31.4 μs.

Crosslinked EPDM, the 4-methyl-1-pentene/propylene copolymer, PP, process oil, clay, and (hydrogenated) SIS were respectively notated as (A), (B), (C), (D), (E), and (F). The mass ratios (parts by mass) of (A) to (F) were calculated based on 100 parts by mass of a total of (A) and (B) or (F) and (C) from the blended materials and the ratios of the components, and described in Table 1.

The following characteristics were measured for the produced compositions of Examples and Comparative Examples. The measurement results are shown in Table 1.

(1) Average Relaxation Time

A relaxation time (spin-spin relaxation time) was measured by a solid echo method according to pulse nuclear magnetic resonance (NMR) at 25° C., and the average time of three samples was calculated. The desired value of the average relaxation time was set to 900 μs or less.

(2) Degree of Noise Insulation Attenuation

It has been known that a degree of noise insulation attenuation and vibration damping property with respect to glass are correlated with each other (the higher the degree of noise insulation attenuation is, the higher the vibration damping property is). Then, the vibration damping property with respect to glass was presumed by measuring the degree of noise insulation attenuation.

Specifically, the composition was first dried at 80° C. in a drier for 24 hours. The composition having a melting temperature of 220° C. was extruded in a Labo Plastomill preheated to 220° C., to mold a test plate having a width of 20 mm, a length of 120 mm, and a thickness of 2 mm. The circumference of the test plate was closed. White noise was emitted toward the test plate from a speaker installed on one side of the test plate, and noise transmitting through the test plate was detected with a microphone installed on the other side of the test plate. The degree of noise insulation attenuation in a zone of 400 to 6300 Hz was measured. The desired value of the degree of noise insulation attenuation was set to 30 dB or more (the vibration damping property with respect to glass was presumed to be also sufficiently high).

(3) Connection Strength

A press-molded piece was obtained by press-molding with reference to JIS K7151 (in place of the extrusion-molded part 2 of the embodiment).

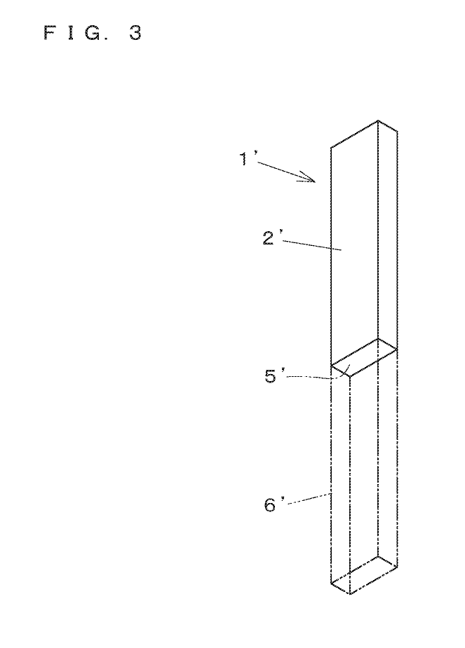

Specifically, the composition was first dried at 80° C. in a drier for 24 hours. A mold preheated to 220° C. in a pressing machine was filled with the composition (a fluorine resin sheet was sandwiched between the mold and the composition in order to prevent fixation). The composition was subjected to hot pressing for 5 minutes, and then promptly subjected to cooling pressing to form a press-molded piece having a width of 10 mm, a length of 80 mm, and a thickness of 4 mm. The press-molded piece was removed, and cut to have one half of the length thereof, thereby providing a press-molded cut piece 2′ having a cut edge 5′ and having a width of 10 mm, a length of 40 mm, and a thickness of 4 mm, as shown in the upper half of FIG. 3.

Next, a die-connected piece was obtained by die-molding with reference to JIS K7152 (in place of the die-molded part 6 of the embodiment), and simultaneously die-connected to the press-molded cut piece 2′. Specifically, the press-molded cut piece 2′ was fitted into a mold (ISO mold type B) preheated to 70° C. so that the cut edge 5′ faced a cavity. The composition having a melting temperature of 250° C. was injected in an injection machine, to obtain a die-molded piece 6′ having a width of 10 mm, a length of 40 mm, and a thickness of 4 mm according to die-molding, as shown in the lower half of FIG. 3, and simultaneously the die-molded piece 6′ was die-connected to the cut edge 5′ of the press-molded cut piece 2′, and cooled, followed by removing the cooled product from the mold, to provide a connected test piece 1′ having a width of 10 mm, a length of 80 mm, and a thickness of 4 mm.

Next, the connection strength of the connected test piece 1′ was measured with reference to JIS K7161. Specifically, an end part of the press-molded cut piece 2′ and an end part of the die-molded piece 6′ were subjected to chuck, and subjected to a tensile test at a test speed of 200 mm/min, to measure strength at fracture. The average value of three samples was taken as connection strength. The desired value of the connection strength was set to 3.1 MPa or more.

(4) Compression Set (CS)

A piece specified in JIS (test for measuring compression set) was subjected to compression distortion of 25% in a height direction with reference to JISK6262 at 70° C. for 24 hours, and the distortion was then released. After 30 minutes, the height of the piece was measured, and the compression set (CS) was calculated from the change in the height before and after the test. The desired value of the compression set was set to 65% or less.

The present invention is not limited to the above-mentioned Examples, and can be appropriately changed and implemented without departing from the spirit of the invention.

### REFERENCE SIGNS LIST

1 glass run
2 extrusion-molded part
3 trim part
4 seal lip part
5 cut edge
6 die-molded part
10 door sash
11 windowpane
1′ connected test piece
2′ press-molded cut piece
5′ cut edge
6′ die-molded piece

1. A thermoplastic elastomer composition comprising: 22 to 50 parts by mass of a crosslinked ethylene/propylene/non-conjugated diene copolymer (A); 25 to 66 parts by mass of a 4-methyl-1-pentene/propylene copolymer (B); and 13 to 30 parts by mass of polypropylene (C), based on 100 parts by mass of a total of (A), (B), and (C).

2. The thermoplastic elastomer composition according to claim 1, wherein the 4-methyl-1-pentene/propylene copolymer (B) contains a 4-methyl-1-pentene component and a propylene component in a ratio of 65:35 to 80:20.

3. The thermoplastic elastomer composition according to claim 1, further comprising 30 to 60 parts by mass of oil (D) and 10 to 20 parts by mass of a filler (E).

4. The thermoplastic elastomer composition according to claim 2, further comprising 30 to 60 parts by mass of oil (D) and 10 to 20 parts by mass of a filler (E).

5. A glass run comprising at least a seal lip made of the thermoplastic elastomer composition according to claim 1.

6. A glass run comprising an extrusion-molded part and a die-molded part die-connected to the extrusion-molded part, wherein the extrusion-molded part and the die-molded part are made of the thermoplastic elastomer composition according to claim 1.
